(19) United States
(12) Patent Application Publication
(10) Pub. No.: US 2019/0045224 A1
(43) Pub. Date: Feb. 7, 2019

(54) METHOD AND APPARATUS OF NON-LOCAL ADAPTIVE IN-LOOP FILTERS IN VIDEO CODING

(71) Applicant: MEDIATEK INC., Hsin-Chu (TW)

(72) Inventors: Yu-Wen HUANG, Taipei City (TW); Ching-Yeh CHEN, Taipei City (TW); Tzu-Der CHUANG, Zhubei City, Hsinchu County (TW); Jian-Liang LIN, Su'ao Township, Yilan County (TW); Yi-Wen CHEN, Taichung City (TW)

(21) Appl. No.: 16/074,004

(22) PCT Filed: Feb. 3, 2017
(86) PCT No.: PCT/CN2017/072819

§ 371 Date: Jul. 30, 2018

Related U.S. Application Data
(60) Provisional application No. 62/291,047, filed on Feb. 4, 2016.

(51) Int. Cl. H04N 19/82; H04N 19/117; H04N 19/176

(52) U.S. Cl. CPC H04N 19/82; H04N 19/176; H04N 19/117

(57) ABSTRACT

A method and apparatus of video coding using Non-Local (NL) denoising filter are disclosed. According to the present invention, the decoded picture or the processed-decoded picture is divided into multiple blocks. The NL loop-filter is applied to a target block with NL on/off control to generate a filtered output. The NL loop-filter process comprises determining, for the target block, a patch group consisting of K nearest reference blocks within a search window located in one or more reference regions and deriving one filtered output which could be one block for the target block or one filtered patch group based on pixel values of the target block and pixel values of the patch group. The filtered output is provided for further loop-filter processing if there is any further loop-filter processing or the filtered output is provided for storing in a reference picture buffer if there is no further loop-filter processing.

### CROSS REFERENCE TO RELATED APPLICATIONS

The present invention claims priority to U.S. Provisional Patent Application, Ser. No. 62/291,047, filed on Feb. 4, 2016. The U.S. Provisional Patent Application is hereby incorporated by reference in its entirety.

### TECHNICAL FIELD

The present invention relates to video coding of video data. In particular, the present invention relates to denoising filter of decoded picture to improve visual quality and/or coding efficiency.

### BACKGROUND

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC and the emerging HEVC (High Efficiency Video Coding) standard.

FIG. 1 illustrates an exemplary adaptive Inter/Intra video coding system incorporating loop processing. For Inter-prediction, Motion Estimation (ME)/Motion Compensation (MC) 112 is used to provide prediction data based on video data from other picture or pictures. Switch 114 selects Intra Prediction 110 or Inter-prediction data and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data are stored in Reference Picture Buffer 134 and used for prediction of other frames. However, the compression process may introduce coding artefacts in the reconstructed video. In order to improve visual quality, various loop filters have been used to reduce the artefact. Accordingly, loop filter 130 may be applied to the reconstructed video data before the video data are stored in the reference picture buffer. For example, AVC/H.264 uses deblocking filter as the loop filter. For HEVC, both deblocking filter and SAO (sample adaptive offset) filter are used as the loop filter.

FIG. 2 illustrates a system block diagram of a corresponding video decoder for the encoder system in FIG. 1. Since the encoder also contains a local decoder for reconstructing the video data, some decoder components are already used in the encoder except for the entropy decoder 210. Furthermore, only motion compensation 220 is required for the decoder side. The switch 146 selects Intra-prediction or Inter-prediction and the selected prediction data are supplied to reconstruction (REC) 128 to be combined with recovered residues. Besides performing entropy decoding on compressed residues, entropy decoder 210 is also responsible for entropy decoding of side information and provides the side information to respective blocks. For example, Intra mode information is provided to Intra-prediction 110, Inter mode information is provided to motion compensation 220, loop filter information is provided to loop filter 130 and residues are provided to inverse quantization 124. The residues are processed by IQ 124, IT 126 and subsequent reconstruction process to reconstruct the video data. Again, reconstructed video data from REC 128 undergo a series of processing including IQ 124 and IT 126 as shown in FIG. 2 and are subject to coding artefacts. The reconstructed video data are further processed by Loop filter 130. Again, AVC/H.264 uses deblocking filter as the loop filter. For HEVC, both deblocking filter and SAO (sample adaptive offset) filter are used as the loop filter.

In the High Efficiency Video Coding (HEVC) system, the fixed-size macroblock of H.264/AVC is replaced by a flexible block, named coding unit (CU). Pixels in the CU share the same coding parameters to improve coding efficiency. A CU may begin with a largest CU (LCU), which is also referred as coded tree unit (CTU) in HEVC. Each CU is a 2N×2N square block and can be recursively split into four smaller CUs until the predefined minimum size is reached. Once the splitting of CU hierarchical tree is done, each leaf CU is further split into one or more prediction units (PUs) according to prediction type and PU partition. Furthermore, the basic unit for transform coding is square size named Transform Unit (TU). For convenience, the slice, LCU, CTU, CU, PU and TU are referred as an image unit.

In HEVC, Intra and Inter predictions are applied to each block (i.e., PU). Intra prediction modes use the spatial neighbouring reconstructed pixels to generate the directional predictors. On the other hand, Inter prediction modes use the temporal reconstructed reference frames to generate motion compensated predictors. The prediction residuals are coded using transform, quantization and entropy coding. More accurate predictors will lead to smaller prediction residual, which in turn will lead to less compressed data (i.e., higher compression ratio).

Inter predictions will explore the correlations of pixels between frames and will be efficient if the scene are stationary or the motion is translational. In such case, motion estimation can easily find similar blocks with similar pixel values in the temporal neighbouring frames. For Inter prediction in HEVC, the Inter prediction can be uni-prediction or bi-prediction. For uni-prediction, a current block is predicted by one reference block in a previous coded picture. For bi-prediction, a current block is predicted by two reference blocks in two previous coded pictures. The prediction from two reference blocks is averaged to form a final predictor for bi-prediction.

Denoising Filter for Image Processing

Beside the loop filter techniques, denoising techniques have been disclosed in recent years as a means to improve visual quality. Among the many denoising approaches, there is a type of technique named as “Non-Local Means or Non-Local Mean (NLM)” denoising to reduce the noise in one image patch according to the statistics of a group of similar reconstructed image patches. For example, Baudes et al. (A. Buades, B. Coll, and J. M. Morel, “A non-local algorithm for image denoising,” in IEEE Computer Society Conference on Computer Vision and Pattern Recognition, 2005, CVPR 2005, vol. 2, pp. 60-65, June 2005,) discloses a non-local denoising algorithm for images. In particular, Baudes et al. discloses a new algorithm, the non-local means (NL-means, NLM), based on a non-local averaging of all pixels in the image. The NL-means method generated a denoised pixel based on a weighted average of neighbouring pixels in the image. A 3D transform-based image denoising technique has been disclosed by Dabov et al. K. Dabov, A. Foi, V. Katkovnik, and K. Egiazarian, “Image denoising by sparse 3-D transform-domain collaborative filtering,” IEEE Trans. Image Process., vol. 16, no. 8, pp. 2080-2094, August 2007). The 3-D transform-domain denoising method groups similar patches into 3-D arrays and deals with these arrays by sparse collaborative filtering. This method utilizes both nonlocal self-similarity and sparsity for image denoising. Recently, Guo et al. discloses a SVD-based denoising technique (Q. Guo, C. Zhang, Y. Zhang, and H. Liu, “An Efficient SVD-Based Method for Image Denoising,” accepted for publication in IEEE Transactions on Circuits and Systems for Video Technology, 2015, available online at http://qguo.weebly.com/publications.html). Guo et al. discloses a nonlocal self-similarity and low-rank approximation (LRA) as a computationally simple denoising method. According to Guo et al., similar image patches are classified by the block-matching technique to form the similar patch groups, which results in the similar patch groups to be low rank. Each group of similar patches is factorized by singular value decomposition (SVD) and estimated by taking only a few largest singular values and corresponding singular vectors. An initial denoised image is generated by aggregating all processed patches. The proposed method by Guo et al. exploits the optimal energy compaction property of SVD to lead an LRA of similar patch groups. The similarity between two patches can be measured in L2-norm distance between two image patches or any other measurement. The various denoising techniques are briefly review as follows.

According to the NL denoising process, the image is divided into multiple patches/blocks. For each target patch, y₀ⁱ, find k most similar patches h₁ⁱ, y₂ⁱ, . . . , yₖⁱ in terms of L2-norm distance or any other measurement. For simplicity, y₁ⁱ is a one-dimensional vector containing the pixels within the two-dimensional patch/block. The k similar patches together with the target patch will then form a patch group Yⁱ, where the i is the group index.

Yⁱ=[y₀ⁱ, y₁ⁱ . . . yₖⁱ] (1)

The goal of image denoising process is to recover the original image from a noisy measurement,

yⱼⁱ(p)=xⱼⁱ(p)+nⱼⁱ(p). (2)

In the above equation, yⱼⁱ(p) is the observed pixel value (i.e., noisy pixel value) in patch j within patch group i, xⱼⁱ(p) is the true pixel value, and nⱼⁱ(p) is the noise value at pixel p (i.e., pixel index within a patch).

After finding out these non-local reference patches and forming a patch group matrix Yⁱ, different denoising kernel can be utilized to reduce the noise term for the patches within the group. Different approaches are described as follows.

Non-Local Denoising Process

The denoised pixels \hat{x}ⱼⁱ(p) is derived as a weighted average of the pixels within the patch group as follows:

$${\hat{x}}_{m}^{i} ( p ) = \frac{1}{z} {\sum }_{j = 0}^{k} {w}_{m , j}^{i} {y}_{j}^{i} ( p ) where {w}_{m , j}^{i} = {e}^{\frac{{‖ {y}_{m}^{i} ( p ) - {y}_{j}^{i} ( p ) ‖}_{2}^{2}}{σ}} , \qquad ( 3 )$$

and Z is a normalization factor, Z=Σⱼ₌₀^{k}w_{j,j}ⁱ.

Non-Local Low-rank Denoising

Assume the noise-free patch group Xⁱ corresponding to the patch group Yⁱ.

Xⁱ=[x₀ⁱ x₁ⁱ . . . xₖⁱ]=Yⁱ+Nⁱ,

where Nⁱ is the associated noise matrix constituting the noise vector corresponding to each patch vector.

The denoising problem with low-rank constraint can be formulated for every group of image patches independently as,

min_{X}_{ⁱ}rank(Xⁱ)s.t.∥yₘⁱ(p)−yⱼⁱ(p)∥₂²≤cσₙ. (4)

The solution for this low-rank constraint is as below.
1. First apply SVD (singular value decomposition) to matrix Yⁱ=UΛV*, where U, V are unitary matrix and Λ is the singular value matrix with non-negative real values on the diagonal.

2. The denoised patch group \hat{X}ⁱ under low-rank constraint is derived as \hat{X}ⁱ=UΛ_{τ}V*, where Λ_{τ} is the matrix with shrunken singular values using either hard-thresholding, soft-thresholding or any other ways with the threshold value τ.

Examples of singular matrix and the truncated results are given below.

$$\begin{matrix}Λ = [ \begin{matrix}1000 & 0 & 0 & 0 \\ 0 & 200 & 0 & 0 \\ 0 & 0 & 50 & 0 \\ 0 & 0 & 0 & 5\end{matrix} ] , & ( 5 ) \\ {Λ}_{10} = [ \begin{matrix}1000 & 0 & 0 & 0 \\ 0 & 200 & 0 & 0 \\ 0 & 0 & 50 & 0 \\ 0 & 0 & 0 & 0\end{matrix} ] , \\ using hard \text{-} thresholding with τ = 10 , and & ( 6 ) \\ {Λ}_{10} = [ \begin{matrix}990 & 0 & 0 & 0 \\ 0 & 190 & 0 & 0 \\ 0 & 0 & 40 & 0 \\ 0 & 0 & 0 & 0\end{matrix} ] , \\ using s oft \text{-} thresholding with τ = 10. & ( 7 )\end{matrix}$$

Block Matching and 3D (BM3D) Filtering

The concept of BM3D is first group all the reference patches and target patch together. Note that the pixels within a patch are put in 2-D manner and the patches will then form a 3-D array. A fixed 3-D transform is then applied to this 3D array. Similarly, soft-thresholding or hard-thresholding is applied to the frequency coefficients. It is believed that truncating the small values in frequency domain can reduce the noise components.

Other Methods

Beside the above mention denoising methods, there are numerous other Non-local (NL) denoising methods that can be used to improve visual quality.

Denoising Filter for Decoded Images in Video Coding

While the above NL denoising methods are mainly focused on image denoising, NL denoising techniques for video coding have also been disclosed. For example, a selectively filter between deblocking filter (DF) and NLM has been disclosed in JCTVC-E206 (M. Matsumura, Y. Bandoh, S. Takamura and H. Jozawa, “In-loop filter based on non-local means filter”, Joint Collaborative Team on Video Coding (JCT-VC) of ITU-T SG16 WP3 and ISO/IEC JTC1/SC29/WG11, 5th Meeting: Geneva, CH, 16-23 Mar. 2011, document: JCTVC-E206). The loop filter structure disclosed in JCTVC-E206 is shown in FIG. 3A. A local decoded picture 310 is filtered using a first loop filter, where the first loop filter corresponds to either NLM 322 or DF 320. The decision is block based, where the local decoded picture 310 is divided into blocks using quadtree. When NLM 322 is used, the associated denoising parameters 321 are provided to the NLM 322. Switch 324 selected a mode according to Rate-Distortion Optimization (RDO). Picture 330 corresponds to the quadtree-partitioned local-decoded picture, where dot-filled blocks indicate NLM filtered blocks and line-filled blocks indicate DF filtered blocks. Picture 340 corresponds to the DF/NLM filtered picture, which is subject to further ALF (adaptive loop filter) process.

FIG. 3B illustrates an example of NLM process according to JCTVC-E206. The similarity measure is based on each 3×3 block 364 (i.e., a patch) around a target pixel 362 in local decoded picture 360 being processed. All of pixels in the reference region 366 are used for computing the weight factors of the filter. NLM filter computes the similarity between the square neighbourhood 364 of target pixel 362 and the square neighbourhood 374 for a location 372 in the reference region 366, in terms of sum of square difference. Using the similarity, NLM filter computes weight factor for the square neighbourhood in the reference region 366. The weighting summation based on the weight factors is the output of the NLM filter. Unlike the patch group for image denoising mentioned above, the patch group for denoising filter in a video coding system according to JCTVC-E206 does not select the K nearest reference patches.

Another picture denoising technique is disclosed in JCTVC-G235 (M. Matsumura, S. Takamura and H. Jozawa, “CE8.h: CU-based ALF with non-local means filter”, Joint Collaborative Team on Video Coding (JCT-VC) of ITU-T SG16 WP3 and ISO/IEC JTC1/SC29/WG11, 7th Meeting: Geneva, CH, 21-30 Nov. 2011, document: JCTVC-G235). In G235. The ALF on/off flag is used to select ALF or NLM. The system use ALF on/off control to partition local decoded picture into blocks and one ALF on/off flag is associated with each block. FIG. 4A illustrates an example of NLM filter according to JCTVC-G235, where partition 410 corresponds to conventional ALF partition and partition 420 corresponds to CU-based ALF with NLM filter. Blocks 430 indicate the legends for various types of blocks. In partition 410, each block is either ALF processed as indicated by a blank box or ALF-skipped block as indicated by a dot-filled block. In partition 430, these ALF-skipped blocks (i.e., with ALF flag off) are now processed by the NLM filter as indicated by line-filled blocks.

FIG. 4B illustrates the use of Sobel filter to determine pattern (440a through 440k) for calculating weighting factor based on JCTVC-G235. Blocks 450 indicate the shape patterns for the target pixel and the tap elements.

### SUMMARY

A method and apparatus of video coding using denoising filter are disclosed. According to the present invention, input data related to a decoded picture or a processed-decoded picture in a video sequence are received. The decoded picture or the processed-decoded picture is divided into multiple blocks. The NL (non-local) loop-filter is applied to a target block with NL on/off control to generate a filtered output block. The NL loop-filter process comprises determining, for the target block, a patch group consisting of K (a positive integer) nearest reference blocks within a search window located in one or more reference regions and deriving one filtered output which could be one block for the target block or one filtered patch group based on pixel values of the target block and pixel values of the patch group. The filtered output blocks are provided for further loop-filter processing if there is any further loop-filter processing or the filtered output blocks are provided for storing in a reference picture buffer if there is no further loop-filter processing. The processed-decoded picture may correspond to an output picture after applying one or more loop filters to the decoded picture, in which the loop filters can be one or a combination of a DF (deblocking filter), a SAO (Sample Adaptive Offset) filter, and an ALF (Adaptive Loop Filter).

The process to derive said one filtered output may be according to NL-Mean (NLM) denoising filter, NL low-rank denoising filter, or BM3D (Block Matching and 3-D) denoising filter. When the BM3D denoising filter is used, an index can be used to select one set of bases from multiple sets of pre-defined bases, multiple sets of signalled bases, or both of the multiple sets of pre-defined bases and the multiple sets of signalled bases. The index can be in a sequence level, picture level, slice level, LCU (largest coding unit) level, CU (coding unit) level, PU (prediction unit) level, or block level.

The filtered output can be derived as a weighted sum of corresponding pixels of said K nearest reference blocks. The K nearest reference blocks can be determined according to a distance measurement between one reference block and one target block, where the distance measurement is selected from a group comprising L2-norm distance, L1-norm distance and structural similarity (SSIM). The distance measurement may also correspond to a sum of square error (SSE) or a sum of absolute difference (SAD), and where a number of nearest reference blocks having the SSE or the SAD equal to zero is limited to T and T is a positive integer smaller than K.

When the filtered output is one filtered patch group or the multiple blocks are overlapped, it is possible that there are multiple filtered sample values for one pixel. Fusion weights for the weighted sum of multiple filtered sample values are based on contents associated with the decoded picture, the processed-decoded picture, the filtered output, or a combination thereof. For example, the fusion weights can be derived according to standard deviation of pixels or noise of the patch group, a rank of the patch group, or similarity between the target block and K nearest reference blocks associated with one overlapped block. Fusion weights for the weighted sum of multiple filtered sample values can be pixel adaptive according to the difference between an original sample and a filtered sample.

One or more NL on/off control flags can be used for the NL on/off control. The NL on/off control may correspond to whether to apply the NL loop-filter to a region or not. Alternatively, the NL on/off control corresponds to whether to use original pixels or filtered pixels for a region. In one example, one high-level NL on/off control flag can be used for the NL on/off control, where all image units associated with a high-level NL on/off control flag can be processed by the NL loop-filter if the high-level NL on/off control flag indicates the NL on/off control being on. The multi-level NL on/off control flags can be in different levels of bitstream syntax. If a higher-level NL on/off control flags indicates the NL on/off control being off, there is no need to signal any lower-level flag. One of said multi-level NL on/off control flags can be signalled in a sequence level, picture level, slice level, LCU (largest coding unit) level, or block level. The search window may have a rectangular shape around one target block, where a first distance from a centre point of the target block to the top edge of the search window is M, a second distance from the centre point of the target block to the bottom edge of the search window is N, a third distance from the centre point of the target block to the left edge of the search window is O, a fourth distance from the centre point of the target block to right the edge of the search window is P, and M, N, O and P are non-negative integers.

### BRIEF DESCRIPTION OF DRAWINGS

FIG. 1 illustrates an exemplary adaptive Inter/Intra video encoding system using transform, quantization and loop processing.

FIG. 2 illustrates an exemplary adaptive Inter/Intra video decoding system using transform, quantization and loop processing.

FIG. 3A illustrates an example of system structure for using Non-Local Means (NLM) denoising filter in a video coding system according to JCTVC-E206.

FIG. 3B illustrates an example of NLM process according to JCTVC-E206, where the similarity measure is based on each 3×3 block (i.e., a patch) around a target pixel in a local decoded picture being processed.

FIG. 4A illustrates an example of NLM filter according to JCTVC-G235, where partitions corresponding to conventional ALF partition and CU-based ALF with NLM filter are shown.

FIG. 4B illustrates the use of Sobel filter to determine patterns for calculating weighting factor based on JCTVC-G235.

FIG. 5 illustrates an example of possible locations of NL denoising in-loop filter in a video encoder according to the present invention.

FIG. 6 illustrates an example of possible locations of NL denoising in-loop filter in a video decoder according to the present invention.

FIG. 7 illustrates an example of search window parameters, where the target patch and the search range for the target patch are shown.

FIG. 8 illustrates an exemplary flowchart for Non-Local Loop Filter according to one embodiment of the present invention.

FIG. 9 illustrates an exemplary flowchart for Non-Local Loop Filter according to another embodiment of the present invention.

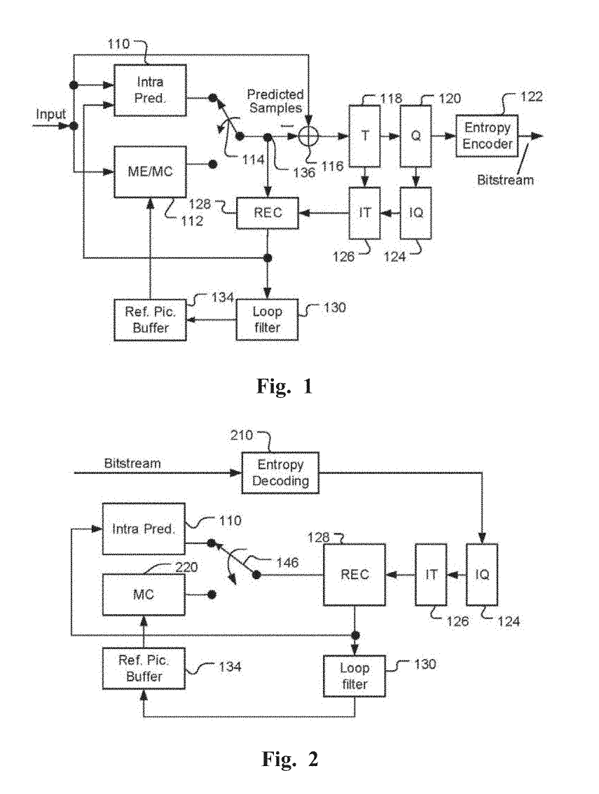

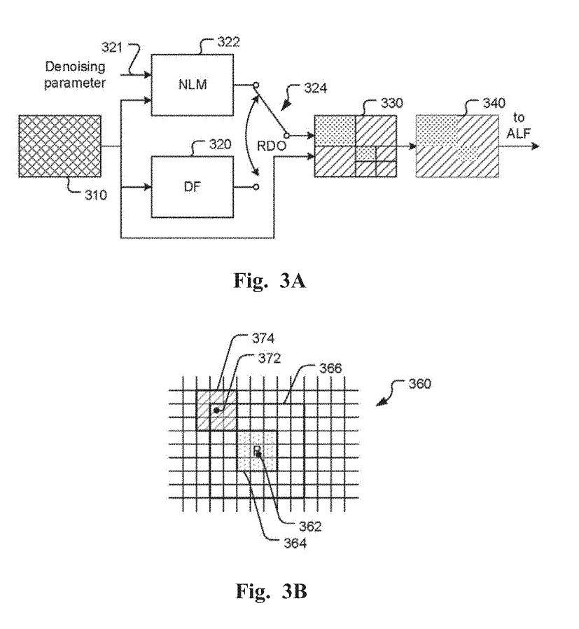

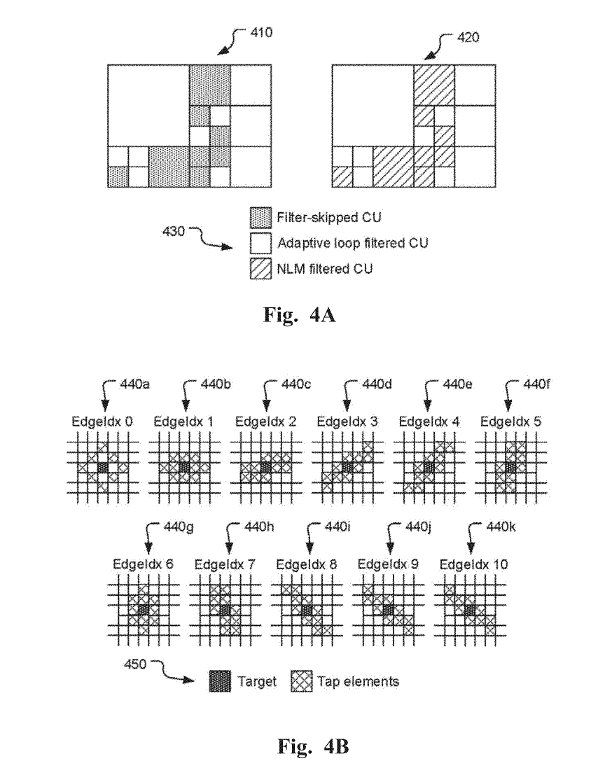

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

Some popular denoising techniques have been briefly reviewed above. These existing deblocking filters belong to a type of local smoothing operations that refer to pixels located near the target pixel and generate filtered pixels as outputs. The locality of the operation restricts the performance of the filtering. Such local operations impose certain restrictions on the filter design. In order to improve the efficiency of denoising filter, the aforementioned Non-local denoising is included as an in-loop filter for video coding in the present invention.

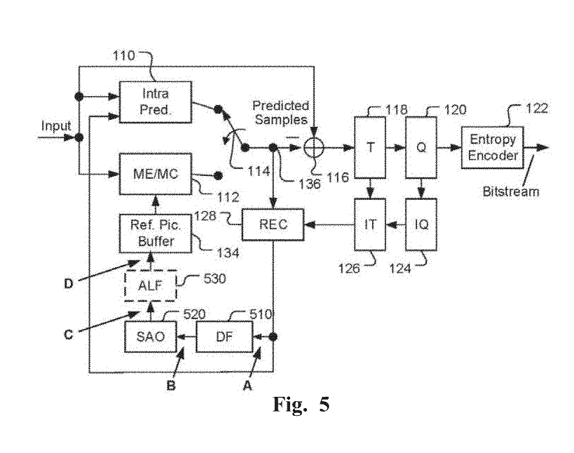

The possible locations of NL denoising in-loop filter (also named as NL denoising loop filter or NL loop-filter in this disclosure) in a video encoder according to the present invention are shown FIG. 5. Since the NL denoising loop filter can be applied in an adaptive fashion, the NL denoising in-loop filter according to the present invention is also referred as NL-ALF (NL adaptive loop filter). In FIG. 5, Deblocking Filter (DF) 510, Sample Adaptive Offset (SAO) 520 and Adaptive Loop Filter (ALF) 530 are three exemplary in-loop filters used in the video encoding. The ALF is not adopted by HEVC. However, it can improve visual quality and could be included in newer coding systems. The NL denoising loop filter according to the present invention is used as an additional in-loop filter that can be placed at the location before DF (i.e., location A), the location after DF and before SAO (i.e., location B), the location after SAO and before ALF (i.e., location C), or after all in-loop filters (i.e., location D).

FIG. 6 illustrates an example of possible locations of NL denoising in-loop filter in a video decoder according to the present invention. In FIG. 6, Deblocking Filter (DF) 510, Sample Adaptive Offset (SAO) 520 and Adaptive Loop Filter (ALF) 530 are three exemplary in-loop filters used in the video decoding. Again, the NL denoising loop filter according to the present invention is used as an additional in-loop filter that can be placed at the location before DF (i.e., location A), the location after DF and before SAO (i.e., location B), the location after SAO and before ALF (i.e., location C), or after all in-loop filters (i.e., location D).

In the NL denoising loop filter according to the present invention, the current image is first divided into several patches (or blocks) with size equal to M×N pixels, where M and N are positive integers. The divided patches can also be overlapped or non-overlapped. When patches are overlapped or the filtered output is one filtered patch group, there may be multiple filtered values for each sample. A weighted sum of multiple filtered sample values can be utilized to fuse multiple filtered values.

While denoised image is likely to have better visual quality, however there is no guarantee that the NL denoised pixels will always have better quality or lower rate-Distortion cost than the pixels without NL denoising. Therefore, the NL denoising loop filter is adaptively applied to the patches according to embodiments of the present invention. The adaptive enable/disable mechanism can be realized by signalling one or more additional bits to indicate whether each patch should be processed by the NL denoising loop filter or not. Details of various aspects of the NL-ALF including parameter settings, on/off controls and the associated entropy coding, fusion of multiple filtered pixels, and searching algorithm and criterion are described as follows.

Parameters Settings

There are multiple parameters to be determined for the disclosed NL denoising loop filter. The parameters may include one or more items belonging to a group comprising search range, patch size, matching window size, patch group size, the kernel parameter (e.g. a for Non-local means denoising and τ for Non-local Low-rank denoising) and the source images. The parameters for performing the NL-ALF process can be pre-determined, implicitly derived, or explicitly signalled. Details of parameter setting are described as follows.

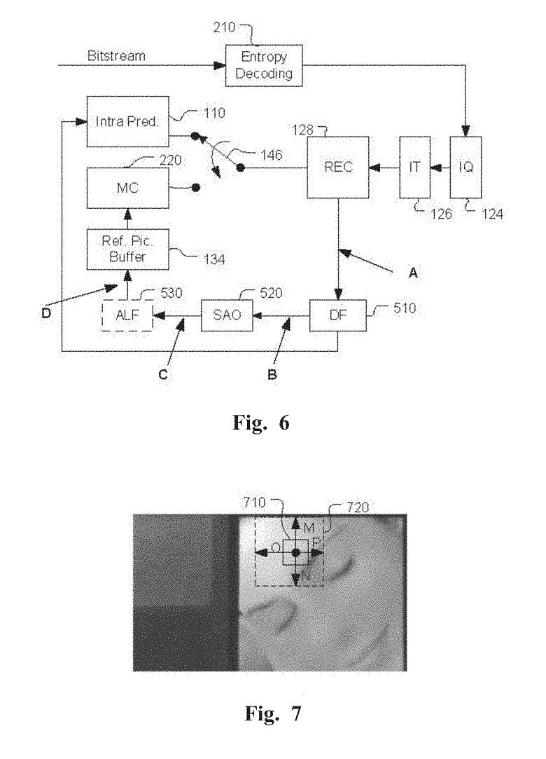

Search range. FIG. 7 illustrates an example of search window parameters. In FIG. 7, the small rectangle 710 is the target patch and the larger dotted rectangle 720 is the search range for the target patch to search for the reference patches. The search range can be specified as a rectangle using the non-negative integer numbers M, N, O, and P, which correspond to the target patch shifted up M points, shifted down N points, shifted left O points and shifted right P points as shown in FIG. 7. The search range can be further specified by the block structure of the codec (e.g., CU/LCU structure). Furthermore, in order to reduce the line buffer associated with the search range, a rectangular search range is preferred over a square search range. For example, M and N can be smaller than O and P. The search range can be further restricted to some pre-defined regions. For example, only the current LCU can be used for the search range. In another example, only the current and left LCUs can be used for the search range. In yet another example, only the current LCU plus W pixel rows at the bottom of the above LCU and V pixel columns at the right side of the left LCU can be used for the search range, where W and V are non-negative integers. In yet another example, only the current LCU except for X pixel rows at the bottom of the current LCU and Y pixel columns at the right side of the current LCU, plus W pixel rows at the bottom of the above LCU and V pixel columns at the right side of the left LCU can be used for the search range, where W, V, X, and Y are non-negative integers. In yet another example, the search range cannot cross the LCU row boundaries or some pre-defined virtual boundaries in order to save the required memory buffers. In yet another example, only the pixels in the left, top, and left-top regions can be used. For example, the P and N in FIG. 7 can be all zeros.

Patch size. Patch size is an M×N rectangular block, where M and N are identical or different non-negative integers. The input image is divided into multiple patches and each patch is one basic unit to perform NL denoising. Note that, the divided patches can be overlapped or non-overlapped. When patches are overlapped, there may be multiple filtered values for the sample in the overlapped area. The weighted average of multiple filtered sample values is utilized to fuse multiple filtered values. Furthermore, the patch size can be determined adaptively according to the content of the processed image.

Matching window size. The pixels within the matching window can be utilized to search for the reference patches. The matching window is usually a rectangle with size MM×NN, where MM and NN are non-negative integers. The matching window is usually centred at the centroid of the target patch and its size can be different from the target patch size. Furthermore, the matching window size can be determined adaptively according to the content of the processed image.

Patch group size. Patch group size, K, is used to specify the number of reference patches. The patch group size can be determined adaptively according to the content of the processed image.

Kernel Parameters. Depending on the specific denoising technique, different kernel parameters may be required. The kernel parameters required are described as follows.

A. Standard deviation of noise (σₙ). Both encoder and decoder may need to estimate the standard deviation of noise. In the codec, the noise is mainly caused by the quantization errors and it is also observed that the quantization error is related to the texture-level of the content. Therefore, an aspect of the present invention discloses a method to learn the relationship between the standard deviation of noise and the content of the reconstructed pixels. For example, a power function y=ax^{b} can be used to specify the relationship, where x represents the standard deviation of the reconstructed pixels (also termed as σᵣ), and y represents the estimated standard deviation of noise. The parameters, a and b, can be off-line trained for different QPs (quantization parameters), different slice type, and any other coding parameters. Furthermore, the selection of the parameters, a and b, can be dependent on the coding information of the current CU, including Inter/Intra mode, uni-/bi-prediction, residual, and QP of reference frames, etc. Beside the power function, the relationship can be piece-wise linear or power function with an offset.

B. Standard deviation of original pixels (σₒ). The standard deviation of the original pixels can be estimated for a patch group or be estimated by using the following equation:

σₒ=\sqrt{σᵣ²−σₙ²}.

Similarly, the standard deviation of original pixels in the SVD spaces can be estimated as below:

$${σ}_{o} = \sqrt{\frac{{λ}_{k}^{2}}{w} - {σ}_{n}^{2}}$$

In the above equation, λₖ is the k-th singular value of the matrix Yⁱ and w is the minimum dimension of Yⁱ.

C. Truncation value (τ). The truncation value τ can be adaptively determined according to the ratio of σₙ and σₒ with/without one scaling factor.

Transform based denoising. The transform based denoising method can be used to remove the noise of a patch group. The discrete cosine transform (DCT), discrete sine transform (DST), Karhunen-Loeve transform (KLT) or pre-defined transforms can be used. For a patch group, a forward transform, which can be 1D, 2D or 3D transform, is first applied. The transform coefficients less than a threshold can be set to zero. The threshold can depend on QPs, slice type, cbf (coded block flag), or other coding parameters. The threshold can be signalled in the bitstream. After the transform coefficients are modified, the backward transform is applied to get the reconstruction pixels of a patch group.

The source images. In the conventional non-local denoising methods, the reference patches are located within the same image (i.e., the current image). In the present invention, the reference patch can be in the current image as well as the reference images. The reference images are the reconstructed images by video codec and are marked as reference images/pictures for current image/picture used for Inter prediction.

The above parameters can be sequence-dependent parameters and signalled at different levels. For example, the parameters can be signalled at a sequence level, picture level, slice level or LCU level. The parameters signalled at a lower level can over-write the settings from a higher level for current NL-ALF process. For example, a default parameter set is signalled at a sequence level and a new parameter set can be signalled for the current slice, if parameter changes are desired. If there is no new parameter set coded for the current slice, then the settings at the sequence level can be used directly.

On/Off Controls and the Associated Entropy Coding

As for the adaptive on-off control for the NL-ALF in the present invention, the use of multi-level on/off control to indicate whether the non-local ALF is applied or not at different levels is disclosed. When higher-level flags indicate the NL-ALF being off, there is no need to signal lower-level flags. The on/off flag can be used to indicate whether to use the original pixels or the filtered pixels for a patch. Alternatively, the on/off flag can be used to indicate whether the NL-ALF process is enable or not for a patch. Examples of multi-level control are shown below. Various examples of syntax levels used to signal the NL-ALF on/off control are described as follows.

1. Sequence-level on/off. A sequence-level on/off flag is signalled in the sequence-level parameters set (e.g. sequence parameter set, SPS) to indicate whether the NL-ALF is enabled or disabled for the current sequence. The on/off control flag for difference components can be separately signalled or jointly signalled.

2. Picture-level on/off. A picture-level on/off flag can be signalled in the picture-level parameters set (e.g. picture parameter set, PPS) to indicate whether the NL-ALF is enabled or disabled for the current picture. The on/off control flag for difference components can be separately signalled or jointly signalled.

3. Slice-level on/off. A slice-level on/off flag can be signalled in the slice-level parameters set (e.g. slice header) to indicate whether the NL-ALF is enabled or disabled for the current slice. The on/off control flag for difference components can be separately signalled or jointly signalled.

4. LCU-level on/off. A LCU-level on/off flag can be signalled for each largest coding unit (LCU) or coding tree unit (CTU) defined in HEVC, to indicate whether the NL-ALF is enabled or disabled for the current CTU. The on/off control flag for difference components can be separately signalled or jointly signalled.

5. Block-level on/off. A block-level on/off flag can be signalled for each block with size PP×QQ (PP and QQ being non-negative integer) to indicate whether the NL-ALF is enabled or disabled for current block. Note that on/off control flag for difference components can be separately signalled or jointly signalled.

6. Besides on and off modes, an additional third mode, such as SliceAllOn in slice level or LCUAllOn in LCU level, respectively can be signalled. If SliceAllOn is selected, then all of LCUs in the current slice will be processed by NL-ALF and the control flags of LCUs can be saved. Similarly, when LCUAllOn is enabled for the current LCU, all of blocks in current LCU are processed by the NL-ALF and the related block-level on/off flags can be saved.

In this invention, encoding algorithms to decide the on/off of the proposed NL-ALF at different levels are also disclosed. At the encoder side, the distortion and rate at block level are calculated first and the mode decision is performed at block level. Next, the low-level distortion and rate can be reused for mode decision of a higher level, such as the LCU level. After accumulating distortions and rates of all LCUs in one slice, slice-level mode decision can be made. By using this method, we only need to calculate the distortions and rates once to avoid redundant computation in multi-level mode decision.

Fusion of Multiple Filtered Pixels

As mentioned earlier, there may be multiple filtered values for the sample in an overlapped area or when the filtered output is one filtered patch group. The weighted average of multiple filtered sample values is utilized to fuse multiple filtered values. In this invention, adaptive fusion weights according to the content of the reconstructed pixels and/or the filtered pixels are disclosed. Some examples are illustrated as follows.

1. The weights are derived according to the standard deviation of the pixels or the noise of each patch group.

2. The weights are derived according to the rank of each patch group. For example, the filtered pixels of the patch group with small ranks will be assigned a higher fusion weight.

3. The weights are derived according to similarity between the reference patch and the current patch.

4. Usually, one weight is calculated and used for all pixels in a patch. According to one embodiment, pixel-adaptive weight is disclosed. Based on the difference between the original sample and the filtered sample, the calculated weight can be further adjusted. For example, if the difference between the original sample and the filtered sample is greater than a threshold, the weight is reduced to half or quarter or even zero. If the difference between the original sample and the filtered sample is smaller than the threshold, the original weight can be used. The threshold can be determined based on the standard deviation of the pixels or the noise of each patch group, quantization parameter of the current CU, current slice, or selected reference frame, Inter/Intra mode, slice type, and residual.

5. In traditional NLM (Non-Local Means or Non-Local Mean), only current patch in one patch group is modified. Therefore, there is no fusion of multiple filtered pixels. According to an embodiment of the present invention, fusion of multiple filtered pixels in NLM process is disclosed. We further modify the other reference patches in one patch group by using current samples (before filtered) or filtered samples in current patch with the corresponding weights. The corresponding weights can be the weights from the similarity, the equal weighting for a patch group, or derived based on standard deviation of the pixels or noise in current patch group.

6. In some embodiments, the on-off flag can be used to control whether to use the original pixels or the filtered pixels for a region, or to control whether the NL-ALF process should be applied or not for a region. For example, the NL-ALF can be applied for every block. In this example, not only the current patch is modified, the reference patches in a patch group are modified as well. After all patches are processed, the on-off flag is used to determine whether the original pixels or the filtered pixels will be used. In this example, for a region with the NL-ALF flag off, the NL-ALF process should be still applied because some pixels in reference patches might be modified by the current patch. In another example, the NL-ALF process of a region is applied only when the NL-ALF flag of this region is on.

Searching Algorithm and Criterion

In NL-ALF according to the present invention, a patch group is formed by collecting the K most similar patches. The similarity is associated with the distance measurement between one reference block and one target block, and can be defined as a sum of square error (SSE) or a sum of absolute difference (SAD) between the current patch and the reference patch. As is understood, the smaller SSE or SAD implies higher similarity. In order to improve the performance of denoising, the number (T) of reference patches with SAD equal to 0 or SSE equal to 0 is further limited, where T is an integer and smaller than the patch group size, K. By using this limitation, more different patches in a patch group are allowed. Therefore, the filtered samples can be more different compared to the original samples. When using SAD or SSE, the difference value or the squared error value of each pixel can be clipped to be within a range. For example, the range can be 0 to 255*255. In another example, the distance measurement may be selected from a group comprising L2-norm distance, L1-norm distance and structural similarity (SSIM).

Predefined or Signalled Transformation Bases

In order to reduce the complexity at the decoder side, another solution is disclosed to project each patch or block onto a pre-defined or signalled bases. An index is firstly transmitted to select one set of bases from multiple sets of pre-defined and/or signalled bases. The index can be transmitted in the sequence level, picture level, slice level, LCU level, CU level, PU level, or block level. After each patch is projected onto the bases, hard-thresholding or soft-thresholding can be applied on the coefficients. The threshold of each basis can be dependent on the coefficients or the significance of the basis. For example, the sum of the coefficients associated with a basis for all the patches is firstly calculated. The coefficient of the basis will be set to zero if the sum of the coefficients associated with the basis for all patches is less than a threshold. In another example, each patch or block is projected onto a partial set of the bases and performed inverse transform based on the partial coefficients only.

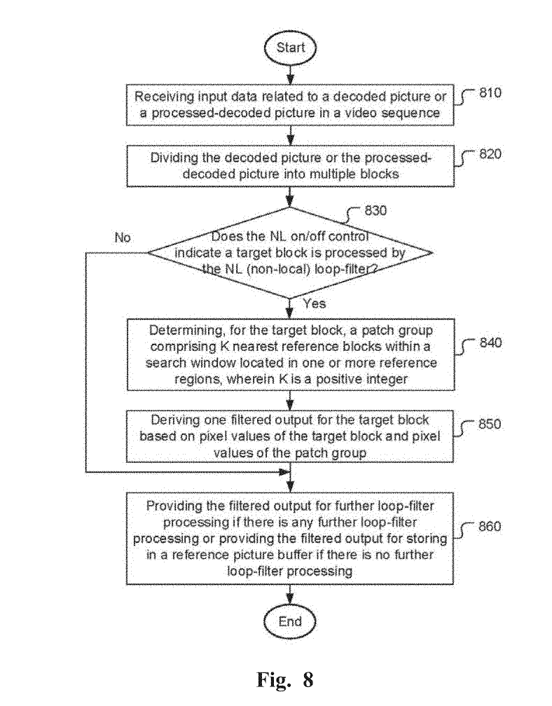

FIG. 8 illustrates an exemplary flowchart for Non-Local Loop Filter according to one embodiment of the present invention. The steps shown in the flowchart may be implemented as program codes executable on one or more processors (e.g., one or more CPUs) at the encoder side or the decoder side. The steps shown in the flowchart may also be implemented based on hardware such as one or more electronic devices or processors arranged to perform the steps in the flowchart. According to this method, input data related to a decoded picture or a processed-decoded picture in a video sequence are received in step 810. FIG. 5 and FIG. 6 illustrate various locations where the present invention can be applied in a video encoder and video decoder respectively. Accordingly, the decoded picture or the processed-decoded picture refers to video data at location A, B, C or D. The decoded picture or the processed-decoded picture is divided into multiple blocks in step 820. In step 830, the NL on/off control is checked to determine whether a target block is processed by the NL (non-local) loop-filter. If the result of step 830 is “Yes”, steps 840 and 850 are performed to apply NL denoising loop filter to the target block. If the result of step 830 is “No”, steps 840 and 850 are bypassed. In step 840, for the target block, a patch group consisting of K nearest reference blocks within a search window located in one or more reference regions are determined, where K is a positive integer. In step 850, one filtered output is derived for the target block based on pixel values of the target block and pixel values of the patch group, the filtered output can be one filtered block or one filtered patch group. The filtered output for further loop-filter processing are outputted if there is any further loop-filter processing or the filtered output are provided for storing in a reference picture buffer if there is no further loop-filter processing in step 860. If a target block is not processed by the NL denoising loop filter, filtered output corresponds to the original target block.

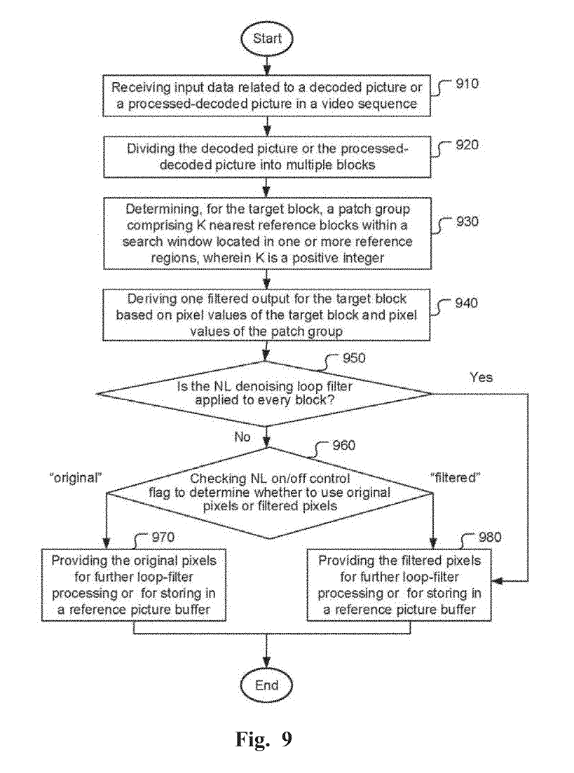

FIG. 9 illustrates an exemplary flowchart for Non-Local Loop Filter according to another embodiment of the present invention. The steps shown in the flowchart may be implemented as program codes executable on one or more processors (e.g., one or more CPUs) at the encoder side or the decoder side. The steps shown in the flowchart may also be implemented based on hardware such as one or more electronic devices or processors arranged to perform the steps in the flowchart. According to this method, input data related to a decoded picture or a processed-decoded picture in a video sequence are received in step 910. For example, the decoded picture or the processed-decoded picture refers to video data at location A, B, C or D as shown in FIG. 5 and FIG. 6. The decoded picture or the processed-decoded picture is divided into multiple blocks in step 920. In step 930, for a target block, a patch group comprising K nearest reference blocks within a search window located in one or more reference regions are determined, where K is a positive integer. In step 940, one filtered output is derived for the target block based on pixel values of the target block and pixel values of the patch group. Whether the NL denoising loop filter is applied to every block is checked in step 950. If the result of step 950 is “No”, step 960 is performed. In step 960, whether the original pixels or the filtered pixels will be used is checked based on the NL on/off control flag. If the original pixels are selected (i.e., the “original” path), the original pixels are outputted for further loop-filter processing or are provided for storing in a reference picture buffer as shown in step 970. If the filtered pixels are selected (i.e., the “filtered” path), the filtered pixels are outputted for further loop-filter processing or are provided for storing in a reference picture buffer as shown in step 980. If the result of step 950 is “Yes”, step 980 is performed.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of image processing for video coding performed by a video encoder or a video decoder, the method comprising:
receiving input data related to a decoded picture or a processed-decoded picture in a video sequence;
dividing the decoded picture or the processed-decoded picture into multiple blocks;
applying NL (non-local) loop-filter to a target block with NL on/off control to generate a filtered output, wherein said applying the NL loop-filter to the target block comprising:
determining, for the target block, a patch group comprising K nearest reference blocks within a search window located in one or more reference regions, wherein K is a positive integer; and
deriving one filtered output for the target block based on pixel values of the target block and pixel values of the patch group; and
providing the filtered output for further loop-filter processing if there is any further loop-filter processing or providing the filtered output for storing in a reference picture buffer if there is no further loop-filter processing.

2. The method of claim 1, wherein the processed-decoded picture corresponds to an output picture after applying one or more loop filters to the decoded picture, wherein said one or more loop filters comprise one or a combination of a DF (deblocking filter), a SAO (Sample Adaptive Offset) filter and an ALF (Adaptive Loop Filter).

3. The method of claim 1, wherein said deriving said one filtered output is according to NL-Mean (NLM) denoising filter, NL low-rank denoising filter, or BM3D (Block Matching and 3-D) denoising filter.

4. The method of claim 3, wherein when the BM3D denoising filter is used, an index is used to select one set of bases from multiple sets of pre-defined bases, multiple sets of signalled bases, or both of the multiple sets of pre-defined bases and the multiple sets of signalled bases.

5. The method of claim 4, wherein the index is signalled in a sequence level, picture level, slice level, LCU (largest coding unit) level, CU (coding unit) level, PU (prediction unit) level, or block level.

6. The method of claim 1, wherein said one filtered output is derived as a weighted sum of corresponding pixels of said K nearest reference blocks.

7. The method of claim 1, wherein said K nearest reference blocks are determined according to a distance measurement between one reference block and one target block, wherein the distance measurement is selected from a group comprising L2-norm distance, L1-norm distance and structural similarity (SSIM).

8. The method of claim 1, wherein said K nearest reference blocks are determined according to a distance measurement between one reference block and one target block, wherein the distance measurement corresponds to a sum of square error (SSE) or a sum of absolute difference (SAD), and wherein a number of nearest reference blocks having the SSE or the SAD equal to zero is limited to T and T is a positive integer smaller than K.

9. The method of claim 1, wherein said multiple blocks correspond to overlapped multiple blocks.

10. The method of claim 1, wherein a weighted sum of multiple filtered sample values is used to fuse said multiple filtered sample values as a final filtered value.

11. The method of claim 10, wherein fusion weights for the weighted sum of multiple filtered sample values are based on contents associated with the decoded picture, the processed-decoded picture, the filtered output, or a combination thereof.

12. The method of claim 11, wherein the fusion weights are derived according to standard deviation of pixels or noise of the patch group, a rank of the patch group, or similarity between the target block and K nearest reference blocks associated with one overlapped block.

13. The method of claim 10, wherein fusion weights for the weighted sum of multiple filtered sample values are pixel adaptive according to a difference between an original sample and a filtered sample.

14. The method of claim 1, wherein one or more NL on/off control flags are used for the NL on/off control, and the NL on/off control corresponds to whether to apply the NL loop-filter to a region or not.

15. The method of claim 1, wherein one or more NL on/off control flags are used for the NL on/off control, and the NL on/off control corresponds to whether to use original pixels or filtered pixels for a region.

16. The method of claim 1, wherein one high-level NL on/off control flag is used for the NL on/off control, and wherein all image units associated with said one high-level NL on/off control flag are processed by the NL loop-filter if said one high-level NL on/off control flag indicates the NL on/off control being on.

17. The method of claim 1, wherein multi-level NL on/off control flags are used for the NL on/off control, and wherein the multi-level NL on/off control flags are in different levels of bitstream syntax.

18. The method of claim 17, wherein if a higher-level NL on/off control flags indicates the NL on/off control being off, there is no need to signal any lower-level flag.

19. The method of claim 1, wherein the search window has a rectangular shape around one target block, and wherein a first distance from a centre point of said one target block to top edge of the search window is M, a second distance from the centre point of said one target block to bottom edge of the search window is N, a third distance from the centre point of said one target block to left edge of the search window is O, a fourth distance from the centre point of said one target block to right edge of the search window is P, and M, N, O and P are non-negative integers.

20. An apparatus of image processing for video coding performed by a video encoder or a video decoder, the apparatus comprising one or more electronic circuits or processors arranged to:
receive input data related to a decoded picture or a processed-decoded picture in a video sequence;
divide the decoded picture or the processed-decoded picture into multiple blocks;
apply NL (non-local) loop-filter to a target block with NL on/off control to generate a filtered output, wherein to apply the NL loop-filter to the target block comprising:
determine, for the target block, a patch group comprising K nearest reference blocks within a search window located in one or more reference regions, wherein K is a positive integer; and
derive one filtered output for the target block based on pixel values of the target block and pixel values of the patch group; and
provide the filtered output for further loop-filter processing if there is any further loop-filter processing or providing the filtered output for storing in a reference picture buffer if there is no further loop-filter processing.
